(19) United States
(12) Patent Application Publication
(10) Pub. No.: US 2022/0121318 A1
(43) Pub. Date: Apr. 21, 2022

(54) Writing Feeling Improvement On Active Pen With Hover Detection

(71) Applicant: Hewlett-Packard Development Company, L.P., Spring, TX (US)

(72) Inventors: Shan-Chih Chen, Taipei City (TW); Chih-Ting Lai, Taipei City (TW)

(73) Assignee: Hewlett-Packard Development Company, L.P., Spring, TX (US)

(21) Appl. No.: 17/296,652

(22) PCT Filed: Jul. 10, 2019
(86) PCT No.: PCT/US2019/041093

§ 371 Date: May 25, 2021

(51) Int. Cl. G06F 3/044; G06F 3/041; G06F 3/0354

(52) U.S. Cl. CPC G06F 3/0442; G06F 2203/04108; G06F 3/03545; G06F 3/04162

(57) ABSTRACT

In one example, an electronic device may include a touch screen display and a touch sensor associated with the touch screen display. The touch sensor is to detect a capacitive coupling between an input pen and the touch screen display. Further, the electronic device may include a controller, coupled to the touch sensor, to detect a hover operational mode of the input pen when the capacitive coupling is in a first threshold range and detect a touch operational mode of the input pen when the capacitive coupling is in a second threshold range. The second threshold range may be greater than the first threshold range.

### BACKGROUND

Electronic devices such as tablets, eReaders, mobile phones, smart phones, personal digital assistants (PDAs), and other such devices are commonly used for providing digital content. Example digital content may be in the form of text, audio and videos files, graphics, animations, images, and the like. Such electronic devices sometimes use or include a touch sensitive display, which may be useful for displaying a user interface that allows a user to interact with the digital content. The user may interact with the touch sensitive display using a stylus or input pen, for example.

### BRIEF DESCRIPTION OF THE DRAWINGS

Examples are described in the following detailed description and in reference to the drawings, in which:

FIG. 1A is a block diagram of an example electronic device, including a controller to detect operational modes of an input pen;

FIG. 1B is a block diagram of the example electronic device of FIG. 1A, depicting additional features;

FIG. 2 is a block diagram of an example electronic device, including a controller to detect operational modes of an input pen based on capacitive coupling between the input pen and a touch screen display;

FIG. 3A illustrates a schematic diagram of the example electronic device of FIG. 2, depicting an example scenario to detect a hover operational mode of the input pen;

FIG. 3B illustrates a schematic diagram of the example electronic device of FIG. 2, depicting an example scenario to detect a touch operational mode of the input pen;

FIG. 4 is a block diagram of an example electronic device including a non-transitory machine-readable storage medium, storing instructions to detect operational modes of an input pen; and

FIG. 5 is an example flow diagram for detecting operational modes of an input pen.

### DETAILED DESCRIPTION

Electronic devices, such as tablets, smart phones, laptops, and the like, are increasingly being used in connection with an input pen or stylus as an input modality. The input pen may be used to interact with a user interface of an electronic device. Further, the input pen may be of two types, one may be without hover detection (e.g Apple pencil™ by Apple Inc.) and other may be with hover detection (e.g., an active pen supporting Windows Ink by Microsoft®). Some example interactions by the input pen with hover detection may include positioning a cursor on a touch screen display of the electronic device and performing other operations similar to the operations performed by an input device (e.g., a mouse). With increasing applications of such input pens, the input pen may include multiple electronic components such as sensors (e.g., an actuator, a force/pressure sensor, an accelerometer sensor, a gyro sensor, and the like) and other components (e.g., an active stylus controller, an audio component, and the like) to support such applications.

During operation, the input pen with hover detection may emit control signals that include information. For example, the information may be pressure applied on a tip of the input pen as sensed by the pressure sensor integrated with the input pen. Further, based on the sensed pressure, a touch operational mode (e.g, to display ink) of the input pen may be detected and transmitted to the electronic device. Thus, a response time in detecting (i.e., a latency from touching of the input pen to triggering of the pressure sensor) and reporting the touch operational mode may be significantly more. In addition, while providing input with the input pen, a user may have to apply pressure (e.g., activation force) because no inking may be allowed when the input pen is in hover mode. For example, for the input pen with 5 g activated force, the user may have to apply additional 5 g of force to write. Therefore, the additional force may impact user experience to write when compared to writing using the input pen without hover detection.

Some example methods may reduce the activation force (e.g., from 169 to 5 g) through mechanical designs. However, such mechanical design may still require some amount of force to be applied and also incur significantly high manufacturing cost, due to the presence of force/pressure sensors.

Examples described herein may provide an electronic device with a touch screen display and a touch sensor to detect a capacitive coupling between an input pen and the touch screen display. The electronic device may include a controller to detect a hover operational mode of the input pen when the capacitive coupling is in a first threshold range. Further, the controller may detect a touch operational mode of the input pen when the capacitive coupling is in a second threshold range. Examples described herein may use a capacitive principle to set the first and second threshold ranges for capacitive coupling to detect the hover operational mode and the touch operational mode of the input pen.

Thus, examples described herein can eliminate an additional force sensor or pressure sensor in the input pen to detect the touch operational mode. Further, examples described herein may enhance user experience in writing using the input pen with hover detection as additional force may not be involved in writing on the touch screen display. Furthermore, since the electronic device may detect the touch operational mode, a response time in detecting and reporting the touch operational mode can be reduced when compared to the input pen performing the detection and reporting functions.

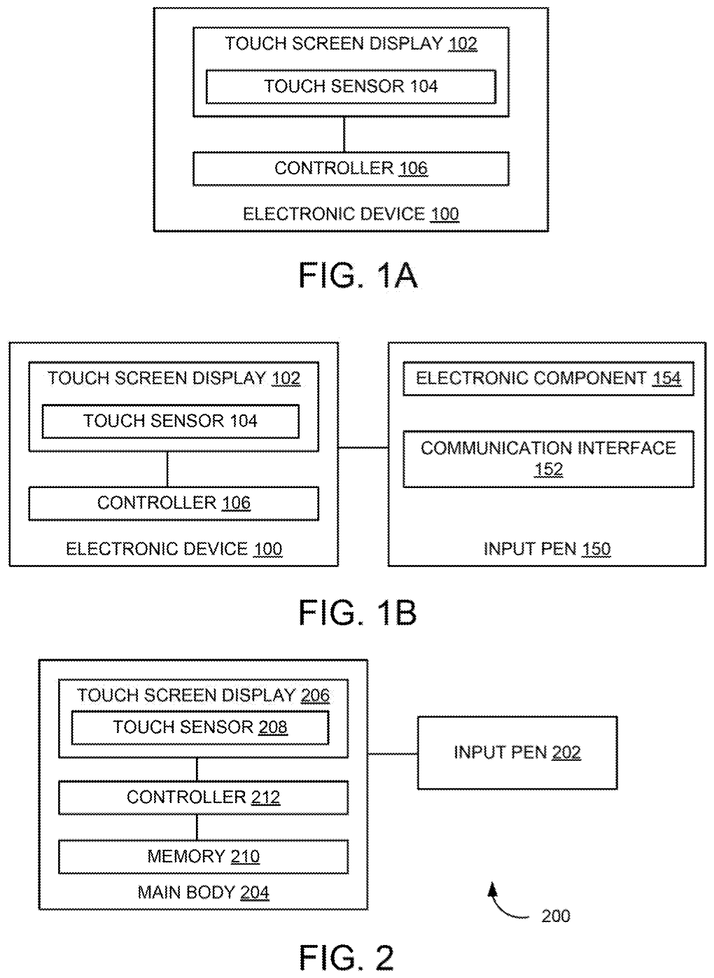

Turning now to the figures, FIG. 1A is a block diagram of an example electronic device 100, including a controller 106 to detect operational modes of an input pen. Example electronic device 100 may include a mobile phone, a laptop computer, a desktop computer, a portable personal computer, an all-in-one personal computer, a tablet computer, a notebook computer, a game player, or the like. Example input pen may be an electronic pen or stylus with hover detection that can provide input to electronic device 100 when the input pen is within a vicinity of electronic device 100 or contacts electronic device 100. Further, the input pen may be detachably connected to electronic device 100.

As shown in FIG. 1A, electronic device 100 may include a touch screen display 102. Example touch screen display 102 can display a user interface that allows a user to interact with digital content. Further, electronic device 100 may include a touch sensor 104 associated with touch screen display 102. Example touch sensor 104 may be a capacitive sensor that can detect a presence of a touch or a proximity of the input pen on a surface of touch screen display 102.

In one example, touch sensor 104 may detect a capacitive coupling between the input pen and touch screen display 102. For example, the capacitive coupling may be a measure of capacitive sensing based on the proximity between the input pen and touch screen display 102. Even though examples herein may be described with respect to capacitive sensing, other types of sensing technology, such as resistive sensing, may also be used to implement the functionalities described herein.

In some example capacitive sensing implementations of electronic device 100, voltage or current is applied to create an electric field. Nearby input pen can cause changes in the electric field, and produce detectable changes in the capacitive coupling that may be detected as changes in voltage, current, or the like. In this example, arrays or other regular or irregular patterns of capacitive sensing elements (e.g., sensor electrodes) may be utilized to create the electric fields.

The capacitive sensing may refer to detection and measurement of the capacitive coupling between touch screen display 102 and the input pen, which may be conductive or has a dielectric different from air. The dielectric coefficient of air is 1. Thus, the capacitive coupling may be low when the input pen approaches touch screen display 102 as air may be present between the input pen and touch screen display 102. Further, the capacitive coupling may increase when a tip of the input pen touches touch screen display 102 as there may be no air between the input pen and touch screen display 102. Accordingly, touch sensor 104 may detect the changes in the capacitive coupling based on proximity of the input pen and touch screen display 102.

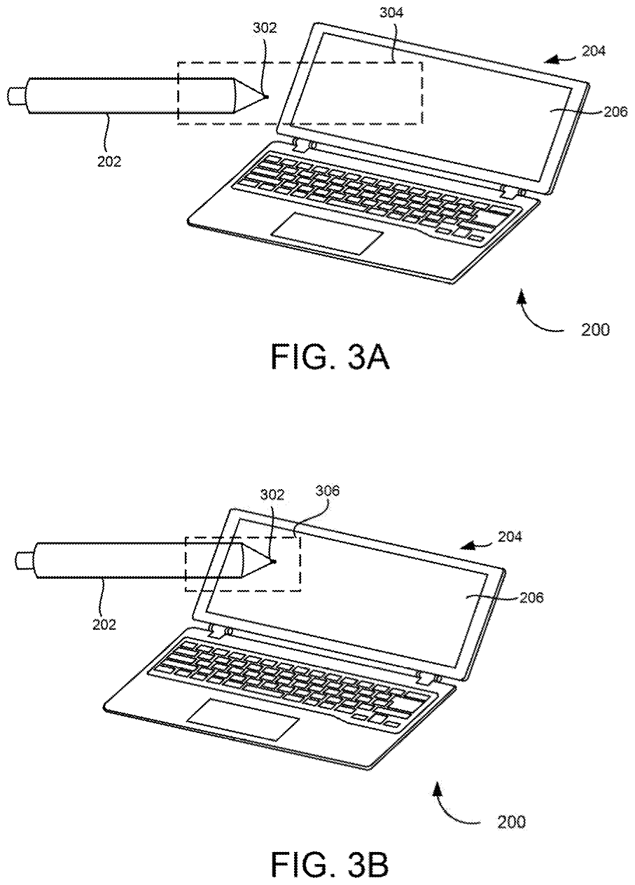

Further, electronic device 100 may include controller 106 coupled to touch sensor 104. In one example, controller 106 may detect a hover operational mode of the input pen when the capacitive coupling is in a first threshold range. In one example, controller 106 may report the hover operational mode of the input pen to electronic device 100 in response to detection of the hover operational mode. Example hover operational mode is described in detail in FIGS. 16 and 3A.

Furthermore, controller 106 may detect a touch operational mode of the input pen when the capacitive coupling is in a second threshold range. In one example, controller 106 may report the touch operational mode of the input pen to electronic device 100. Further, controller 106 may display ink on touch screen display 102 in response to detection of the touch operational mode. In one example, the first threshold range and the second threshold range may be set based on a distance between the tip of the input pen and touch screen display 102. Further, the second threshold range may be greater than the first threshold range. Example touch operational mode is described in detail in FIG. 16.

FIG. 1B is a block diagram of the example, electronic device of FIG. 1A, depicting additional features. For example, similarly named elements of FIG. 1B may be similar in structure and/or function to elements described with respect to FIG. 1A. As shown in FIG. 1B, electronic device 100 may be detachably connected to input pen 150. In some examples, input pen 150 may provide input to electronic device 100 when input pen 150 is within a vicinity (e.g., the hover operational mode) of touch screen display 102 or contacts (e.g., the touch operational mode) touch screen display 102.

As shown in FIG. 1B, input pen 150 may include a communication interface 152. For example, input pen 150 may transmit the input or data to electronic device 100 wirelessly through communication interface 152 (e.g., a Bluetooth interface). The Bluetooth interface can enable wireless data transmission between input pen 150 and electronic device 100 using a radio technology, such as a frequency-hopping spread spectrum, among others. In another example, the tip of input pen 150 may be designed as a bi-directional communication device including a transmitter and a receiver to communicate with electronic device 100. Further, input pen 150 may include an electronic component 154 to provide different control signals corresponding to operations of input pen 150. Example control signal may include a beacon signal based on a location of input pen 150 and additional information corresponding to the hover operational mode and the touch operational mode. Example additional information may be transmitted at set times with respect to the beacon signal that are known or are communicated to electronic device 100.

In one example, electronic device 100 may receive information from input pen 150 indicating a first location of the input pen in a first manner upon detecting the hover operational mode. Example first manner may include presenting a cursor on touch screen display 102 at the first location approximating that of hovering input pen relative to touch screen display 102. For example, when input pen 150 hovers on touch screen display 102, the cursor may appear to select a file displayed on touch screen display 102.

In another example, electronic device 100 may receive information from input pen 150 indicating a second location of input pen 150 in a second manner differing from the first manner upon detecting the touch operational mode. Example second manner may include presenting a point or other indicia on touch screen display 102 at the second location indicative of a contact of input pen 150 on a surface of touch screen display 102.

FIG. 2 is a block diagram of an example electronic device 200, including a controller 212 to detect operational modes of an input pen 202 based on capacitive coupling between input pen 202 and a touch screen display 206. Example electronic device 200 may include input pen 202 and a main body 204 detachably connected to input pen 202.

As shown in FIG. 2, main body 204 may include touch screen display 206 including a touch sensor 208 to detect a capacitive coupling between input pen 202 and touch screen display 206. Further, main body 204 may include a memory 210 to store a first threshold and a second threshold. In one example, the second threshold may be greater than the first threshold. Further, the second threshold may be set such that input pen 202 touches touch screen display 206 when the capacitive coupling is at the second threshold. In the example shown in FIG. 2, memory 210 is shown as a part of electronic device 200, however, memory 210 can also reside in an external storage device, such as a hard disk, a storage card, or a data storage medium and can be accessible by electronic device 200.

Furthermore, main body 204 may include controller 212 to detect operational modes (e.g., a hover operational mode and a touch operational mode) of input pen 202. In one example, controller 212 may detect the hover operational mode of input pen 202 when the capacitive coupling is at or above the first threshold and below the second threshold. Further, controller 212 may receive first data from input pen 202 in the hover operational mode. In one example, controller 212 may receive the first data at a first bit rate. Example hover operational mode is described in FIG. 3A.

In another example, controller 212 may detect the touch operational mode of the input pen when the capacitive coupling is at or above the second threshold. Further, controller 212 may receive second data from input pen 202 in the touch operational mode. In one example, controller 212 may receive the second data different from the first data at a second bit rate greater than the first bit rate. Example second data may include information to trigger inking on touch screen display 206 based on a report of the touch operational mode. Example touch operational mode is described in FIG. 3B.

In one example, controller 212 may switch between the hover operational mode and the touch operational mode of input pen 202 based on the capacitive coupling detected between input pen 202 and touch screen display 206.

Electronic device (e.g., 100 and 200) of FIGS. 1A, 1B, and 2 may include computer-readable storage medium including (e.g., encoded with) instructions executable by a processor to implement functionalities described herein in relation to FIGS. 1A, 1B, and 2. In some examples, the functionalities described herein, in relation to instructions to implement functions of components of electronic device (e.g., 100 and 200) and any additional instructions described herein in relation to the storage medium, may be implemented as engines or modules including any combination of hardware and programming to implement the functionalities of the modules or engines described herein. The functions of components of electronic device (e.g., 100 and 200) may also be implemented by a respective processor. In examples described herein, the processor may include, for example, one processor or multiple processors included in a single device or distributed across multiple devices.

FIG. 3A illustrates a schematic diagram of example electronic device 200 of FIG. 2, depicting an example scenario to detect the hover operational mode of input pen 202. For example, similarly named elements of FIG. 3A may be similar in structure and/or function to elements described with respect to FIG. 2. As shown in FIG. 3A, a tip 302 of input pen 202 is not in contact with touch screen display 206 of main body 204, but within a vicinity of touch screen display 206 (e.g., as shown by 304) such that both input pen 202 and main body 204 are communicatively connected through a communication interface (e.g., Bluetooth interface). Thus, the hover operational mode of input pen 202 may be detected based on the capacitive coupling between input pen 202 and touch screen display 206 as described in FIG. 2. In the hover operational mode, input pen 202 may transmit a beacon signal corresponding to a location of input pen 202, input pen gestures to manipulate data on touch screen display 206, and the like.

FIG. 38 illustrates a schematic diagram of example electronic device 200 of FIG. 2, depicting an example scenario to detect a touch operational mode, of input pen 202. For example, similarly named elements of FIG. 3B may be similar in structure and/or function to elements described with respect to FIG. 2. As shown in FIG. 3B, tip 302 of input pen 202 is in contact with touch screen display 206 of main body 204 (e.g., as shown by 306). Thus, the touch operational mode of input pen 202 may be detected based on the capacitive coupling between input pen 202 and touch screen display 206 as described in FIG. 2. In the touch operational mode, input pen 202 may transmit input data or information associated with operations of the touch operational mode (e.g., to ink or write) to modify a graphical user interface of touch screen display 206.

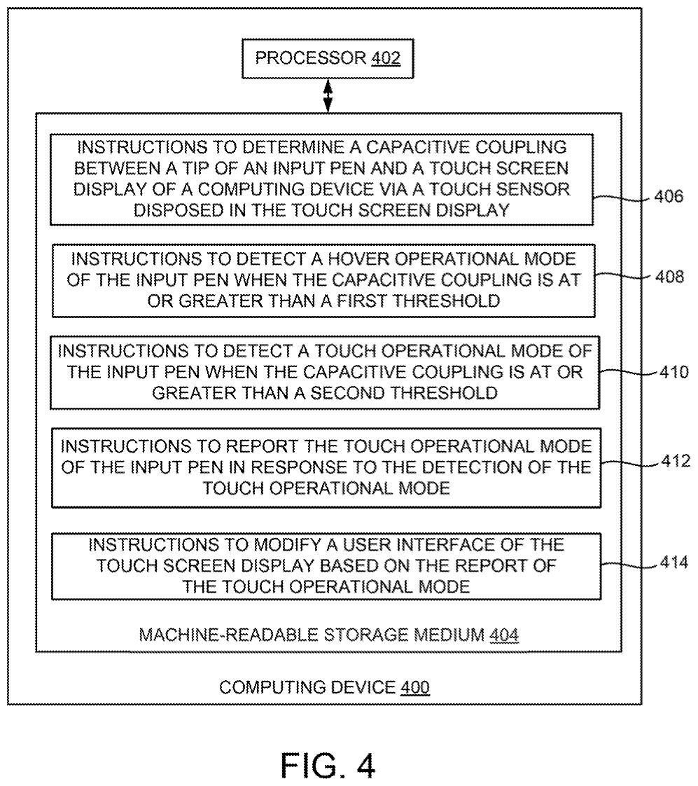

FIG. 4 is a block diagram of an example computing device 400 including a non-transitory machine-readable storage medium 404, storing instructions (e.g., 406 to 414) to detect operational modes of an input pen. Computing device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to computing device 400.

As shown in FIG. 4, machine-readable storage medium 404 may store instructions 406-414. In an example, instructions 406-414 may be executed by processor 402 to to detect operational modes of the input pen. Instructions 406 may be executed by processor 402 to determine a capacitive coupling between a tip of the input pen and a touch screen display of computing device 400 via a touch sensor disposed in the touch screen display.

Instructions 408 may be executed by processor 402 to detect a hover operational mode of the input pen when the capacitive coupling is at or greater than a first threshold. Further, instructions may be executed by processor 402 to report the hover operational mode of the input pen in response to the detection of the hover operational mode and perform a function on the touch screen display in response to a first control signal received from the input pen during the hover operational mode while the input pen is not in contact with the touch screen display.

For example, instructions may be executed by processor 402 to receive information from the input pen indicating a first location of the input pen in a first manner upon detecting the hover operational mode. Example first manner may include presenting a cursor on the touch screen display at the first location approximating that of hovering input pen relative to the touch screen display.

Instructions 410 may be executed by processor 402 to detect a touch operational mode of the input pen when the capacitive coupling is at or greater than a second threshold. In one example, the second threshold may be greater than the first threshold. Instructions 412 may be executed by processor 402 to report the touch operational mode of the input pen in response to the detection of the touch operational mode.

In one example, instructions may be executed by processor 402 to receive information from the input pen indicating a second location of the input pen in a second manner differing from the first manner upon detecting the touch operational mode. For example, the second manner may include presenting a point or other indicia on the touch screen display at the second location indicative of a contact of the input pen on a surface of the touch screen display.

For example, instructions may be executed by processor 402 to manipulate data on the touch screen display in response to a second control signal received from the input pen during the touch operational mode while the input pen is in contact with the touch screen display. Further, instructions 414 may be executed by processor 402 to modify a user interface of the touch screen display based on the report of the touch operational mode, for instance, via triggering inking.

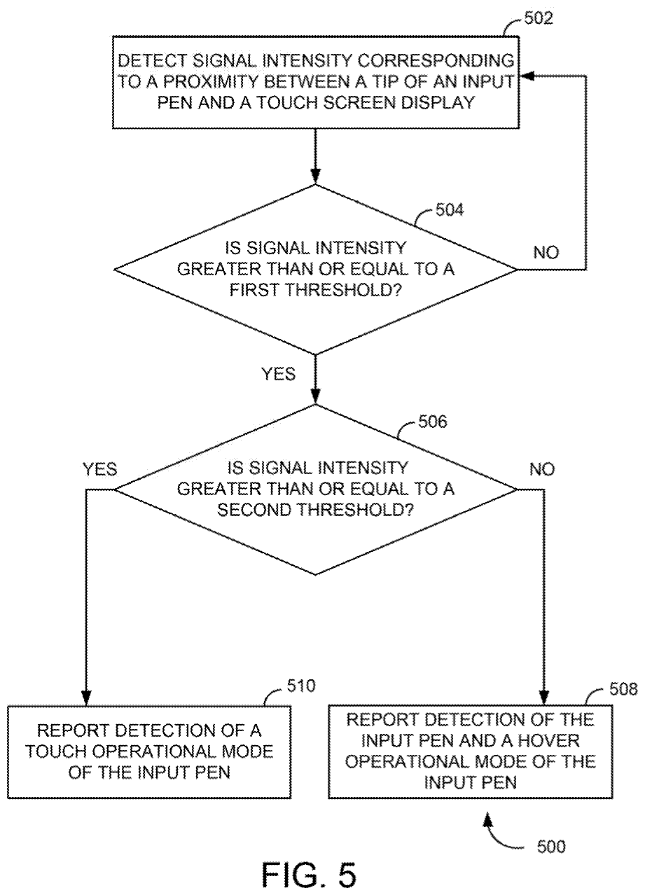

FIG. 5 is an example flow diagram 500 for detecting operational modes of an input pen. It should be understood that the process depicted in FIG. 5 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed, by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

In one example, based on capacitance principle, coupling voltage between the input pen and a touch screen display may be low when the input pen is not in contact with the touch screen display as there may be air between a tip of the input pen and the touch screen display. Further, when the tip touches the touch screen display, the coupling voltage may increase because there is no air between the tip and the touch screen display. Thus, a first threshold and a second threshold may be set based on the capacitance principle.

At 502, signal intensity corresponding to a proximity between a tip of the input pen and a touch screen display may be detected. In one example, the signal intensity may be detected based on capacitive coupling between the input pen and the touch screen display. At 504, a check may be made to determine whether the signal intensity is greater than or equal to the first threshold. When the signal intensity is less than the first threshold, process of 502 may be repeated. At 506, a check may be made to determine whether the signal intensity is greater than or equal to the second threshold when the signal intensity is greater than or equal to the first threshold.

At 508, detection of a hover operational mode of the input pen may be reported when the signal intensity is less than the second threshold. At 510, detection of a touch operational mode of the input pen may be reported when the signal intensity is greater than or equal to the second threshold.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing, examples. It is understood, however, that other forms, details, and examples can be made without departing from the spirit and scope of the present subject matter that is defined in the following claims.

What is claimed is;

1. An electronic device comprising:
a touch screen display;
a touch sensor associated with the touch screen display, wherein the touch sensor is to detect a capacitive coupling between an input pen and the touch screen display; and
a controller coupled to the touch sensor, wherein the controller is to:
detect a hover operational mode of the input pen when the capacitive coupling is in a first threshold range; and
detect a touch operational mode of the input pen when the capacitive coupling is in a second threshold range, wherein the second threshold range is greater than the first threshold range.

2. The electronic device of claim 1, wherein the controller is to:
report the hover operational mode of the input pen to the electronic device in response to detection of the hover operational mode; and
report the touch operational mode of the input pen to the electronic device and display ink on the touch screen display in response to detection of the touch operational mode.

3. The electronic device of claim 1, wherein the controller is to:
receive, from the input pen, information indicating a first location of the input pen in a first manner upon detecting the hover operational mode; and
receive, from the input pen, information indicating a second location of the input pen in a second manner differing from the first manner upon detecting the touch operational mode.

4. The electronic device of claim 3, wherein the first manner comprises presenting. a cursor on the touch screen display at the first location approximating that of hovering input pen relative to the touch screen display, wherein the second manner comprises presenting a point or other indicia on the touch screen display at the second location indicative of a contact of the input pen on a surface of the touch screen display.

5. The electronic device of claim 1, wherein the first threshold range and the second threshold range are set based on a distance between a tip of the input pen and the touch screen display.

6. An electronic device comprising:
an input pen; and
a main body detachably connected to the input pen, wherein the main body comprises:
a touch screen display including a touch sensor to detect a capacitive coupling between the input pen and the touch screen display;
memory to store a first threshold and a second threshold, the second threshold being greater than the first threshold; and
a controller coupled to the touch sensor and the memory, wherein the controller is to:
detect a hover operational mode of the input pen when the capacitive coupling is at or above the first threshold;
receive first data from the input pen in the hover operational mode;
detect a touch operational mode of the input pen when the capacitive coupling is at or above the second threshold; and
receive second data from the input pen in the touch operational mode.

7. The electronic device of claim 6, wherein the controller is to:
receive, in the hover operational mode, the first data at a first bit rate;
receive, in the touch operational mode, the second data different from the first data at a second bit rate greater than the first bit rate.

8. The electronic device of claim 6, wherein the second data is to include information to trigger inking on the touch screen display based on a report of the touch operational mode.

9. The electronic device of claim 6, wherein the controller is to switch between the hover operational mode and the touch operational mode of the input pen based on the capacitive coupling detected between the input pen and the touch screen display.

10. The electronic device of claim 6, wherein the second threshold is set such that the input pen touches the touch screen display when the capacitive coupling is at the second threshold

11. A non-transitory computer-readable storage medium encoded with instructions that, when executed by a computing device, cause the computing device to:
determine a capacitive coupling between a tip of an input pen and a touch screen display of the computing device via a touch sensor disposed in the touch screen display;
detect a hover operational mode of the input pen when the capacitive coupling is at or greater than a first threshold;
detect a touch operational mode of the input pen when the capacitive coupling is at or greater than a second threshold, wherein the second threshold is greater than the first threshold;
report the touch operational mode of the input pen in response to the detection of the touch operational mode; and
modify a user interface of the touch screen display based on the report of the touch operational mode.

12. The non-transitory computer-readable storage medium of claim 11, further comprising instructions to:
receive, from the input pen, information indicating a first location of the input pen in a first manner upon detecting the hover operational mode, wherein the first manner comprises presenting a cursor on the touch screen display at the first location approximating that of hovering input pen relative to the touch screen display.

13. The non-transitory computer-readable storage medium of claim 2, further comprising instructions to:
receive, from the input pen, information indicating a second location of the input pen in a second manner differing from the first manner upon detecting the touch operational mode, wherein the second manner comprises presenting a point or other indicia on the touch screen display at the second location indicative of a contact of the input pen on a surface of the touch screen display.

14. The non-transitory computer-readable storage medium of claim further comprising instructions to:
report the hover operational mode of the input pen in response to the detection of the hover operational mode; and
perform a function on the touch screen display in response to a first control signal received from the input pen during the hover operational mode while the input pen is not in contact with the touch screen display.

15. The non-transitory computer-readable storage medium of claim 1 further comprising instructions to:
manipulate data on the touch screen display in response to a second control signal received from the input pen during the touch operational mode while the input pen is in contact with the touch screen display.
